(19) United States
(12) Patent Application Publication
(10) Pub. No.: US 2010/0314310 A1
(43) Pub. Date: Dec. 16, 2010

(54) ANAEROBIC DIGESTION PROCESS AND APPARATUS

(75) Inventor: John Anderson James Mullet, Cambridgeshire (GB)

Correspondence Address: SHERIDAN ROSS PC, 1560 BROADWAY, SUITE 1200, DENVER, CO, 80202, US

(73) Assignee: BIO GROUP LIMITED, Cambridgeshire (GB)

(21) Appl. No.: 12/744,430

(22) PCT Filed: Oct. 29, 2008
(86) PCT No.: PCT/GB08/03671

§ 371 Date: Aug. 10, 2010

(30) Foreign Application Priority Data
Nov. 28, 2007 (GB) 0723299.4

(51) Int. Cl. C02F 3/28

(52) U.S. Cl. 210/601; 210/209; 210/218

(57) ABSTRACT

A method of anaerobically digesting organic material, comprising: providing a reaction chamber (12) comprising first and second cells (20,22) linked by a passageway (24) for flow of organic waste slurry from a bottom region of one cell to a bottom region of another cell; placing an organic waste slurry (S) in the reaction chamber (12) to fill at least the bottom region of each cell; displacing organic waste slurry (S) through the passageway (24) from the first cell (20) to the second cell (22) to build a head Δh of organic waste slurry (S) in the second cell (22); and discharging the head Δh of organic waste slurry (S) from the second cell (22) to agitate organic waste slurry in the reaction chamber (12).

### TECHNICAL FIELD

The present invention relates to a method of anaerobically digesting organic material, and to apparatus for anaerobic digestion of organic material.

### BACKGROUND ART

Anaerobic digestion is a process whereby organic waste is broken down in a controlled, oxygen-free environment by bacteria naturally occurring in the waste material. Methane-rich biogas is produced, thus facilitating renewable energy generation. There is great interest in optimising anaerobic digestion of organic waste in order to increase such renewable energy generation.

There are certain problems associated with anaerobic digestion of organic waste (e.g. food waste) which are soup or paste-like; that is, organic waste which is neither solid nor low-viscosity liquid, but instead a liquid containing high solids (perhaps up to 25% by weight). Such organic waste “slurries” have a tendency to separate into three phases if left standing during anaerobic digestion. Larger solid particles of organic waste have a tendency to settle to form a sediment phase. On the other hand, smaller particles of organic waste have a tendency to float to form a foam-like raft, particularly due to generated biogas becoming trapped on the surface of such particles.

In this way, a layer of liquid, depleted of solid matter, might form between the foam-like raft and sediment phase. In order to avoid such separation, various steps have been proposed to agitate the slurry during the anaerobic digestion process. These steps include: the use of paddles to stir the slurry; the use of pumps to keep the slurry flowing; and bubbling collected biogas through the slurry.

A system has been proposed which uses biogas production to displace slurry from one cell to another in a twin cell reactor. However, such displacement is relatively slow and does not prevent separation of the organic waste slurry into three phases.

The present applicant has sought to address some of the problems associated with processing organic waste slurries.

### DISCLOSURE OF INVENTION

In accordance with a first aspect of the present invention there is provided a method of anaerobically digesting organic material, comprising: providing a reaction chamber comprising first and second cells linked by a passageway for flow of organic waste slurry from a bottom region of one cell to a bottom region of another cell; placing an organic slurry in the reaction chamber to fill at least the bottom region of each cell; displacing organic waste slurry through the passageway from the first cell to the second cell to build a head of organic waste slurry in the second cell; and discharging the head of organic waste slurry from the second cell to agitate organic waste slurry in the reaction chamber.

The present applicant has appreciated that such discharging of the head of organic waste slurry or “flushing” may be used to reduce the extent to which organic waste slurries separate into three distinct phases. At least some of the head of organic waste slurry may be discharged back into the first cell, thereby effecting “backflushing”. Alternatively or additionally, at least some of the head of organic waste slurry may be discharged into a third cell, downstream of the first and second cells.

The head of organic waste slurry may be discharged from the second cell at a greater rate than it is built up by active displacement from the first cell. For example, the head of organic waste slurry may be discharged at least 10 times faster, possibly even 50 times faster, than it is built up. Rapid discharging of the head of organic waste slurry increases the flushing or backflushing action and hence agitation of the organic waste slurry in the reaction chamber.

Preferably, the organic waste slurry is displaced actively. In other words, external factors are brought to bear to displace the organic waste slurry, rather than just rely on internal biogas production to drive any such displacement. One advantage of such active displacement is that it may be considerably faster than natural or passive displacement. The organic waste slurry may be actively displaced by pressurizing the first cell relative to the second cell. For example, the first cell may be pressurized relative to the second cell by pumping gas into the first cell whilst venting fluid from the second cell. The gas pumped into the first cell may comprise at least a component of a biogas. The at least one component of the biogas may be recycled from the reaction chamber.

The present applicant has found that an increase in pressure (e.g. to a pressure of 0.3 bar or more over atmospheric pressure, perhaps about 1 bar or even about 2 bar) has a beneficial effect on the anaerobic digestion process. At elevated pressure, the present applicant has surprisingly found that the foam-like raft layer tends to denaturalize, helping to offset the tendency for the organic waste slurry to separate into at least one of the three phases. Thus, it may well be beneficial to maintain the reaction chamber at a pressure above atmospheric pressure throughout anaerobic digestion of organic material

The head of organic waste slurry may be discharged by rapidly depressurizing the first cell. For example, pumped gas may be vented from the first cell in such a way that there is a significant percentage drop in over-pressure within a few seconds, perhaps within 1-2 seconds. The vented gas may be stored for subsequent use.

Preferably, the steps of displacing to build the head of organic waste slurry and discharging the head of organic waste material are part of a cycle that is repeated during anaerobic digestion of organic material. The cycle may be repeated continuously, perhaps about once per hour, at least during initial processing of organic material.

The reaction chamber may further comprise a third cell linked to the second cell by a respective passageway for flow of organic waste slurry from the bottom region of the second cell to a bottom region of the third cell. The method may further comprise displacing organic waste slurry through the respective passageway from the second cell to the third cell to build a head of organic waste slurry in the third cell; and discharging the head of organic waste slurry from the third cell to agitate organic waste slurry in the reaction chamber. The head of organic waste slurry in the second cell may be built and discharged before the head of organic waste slurry in the third cell is built and discharged. In this way, cells may be used sequentially to agitate organic waste slurry in the reaction chamber. In this way, there may be a “fuzzy flow” of the organic waste slurry from the first cell to the third cell in a downstream direction, with “quasi” batch processing of organic waste slurry between adjacent pairs of cells.

In accordance with a second aspect of the present invention, there is provided apparatus for anaerobic digestion of organic waste, comprising: a reaction chamber for receiving an organic waste slurry, the reaction chamber comprising first and second cells linked by a passageway for flow of organic waste slurry from a bottom region of one cell to a bottom region of another cell; means for displacing organic waste slurry through the passageway from the first cell to build a head of organic waste slurry in the second cell; and means for discharging the head of organic waste slurry from the second cell to agitate organic waste slurry in the reaction chamber.

The first cell may be a pressure vessel, and the displacing means may comprise a supply line of pressurized gas for supplying pressurized gas to the first cell. For example, the displacing means may comprise a pump for pumping gas under pressure into the first cell. The second cell may be vented to allow the head of organic fluid to build as gas is pumped under pressure into the first cell. The discharging means may comprise a valve for releasing pressurized gas from the first cell. The valve may control gas flow from the first cell to the second cell.

The first and second cell may be arranged side by side. The reaction vessel may further comprise a third cell linked by a passageway for flow of organic waste slurry from a bottom region of the third cell to a bottom region of the second cell. The first, second and third cells may be arranged in series, with the first cell being configured to receive organic waste slurry entering the reaction vessel, and the third cell being configured to discharge organic waste slurry leaving the reaction chamber. Additional cells may be added to the reaction chamber.

The reaction chamber may be a single tank with at least one internal partition wall separating the first cell from the second cell. The passageway may comprise an opening in the internal partition wall between the first and second cells. The opening may be located in a bottom region of the internal partition wall. Alternatively, the reaction chamber may comprise a first tank for the first cell and a second tank for the second cell, with the passageway comprising a pipe extending from the first tank to the second tank.

### BRIEF DESCRIPTION OF DRAWINGS

An embodiment of the invention will now be described by way of example with reference to the accompanying drawings, in which:

FIG. 1 shows schematically apparatus according to one aspect of the present invention;

FIG. 2 shows first detail of operation of apparatus of FIG. 1 in use; and

FIG. 3 shows second detail of operation of apparatus of FIG. 1.

### DETAILED DESCRIPTION OF SPECIFIC EMBODIMENT

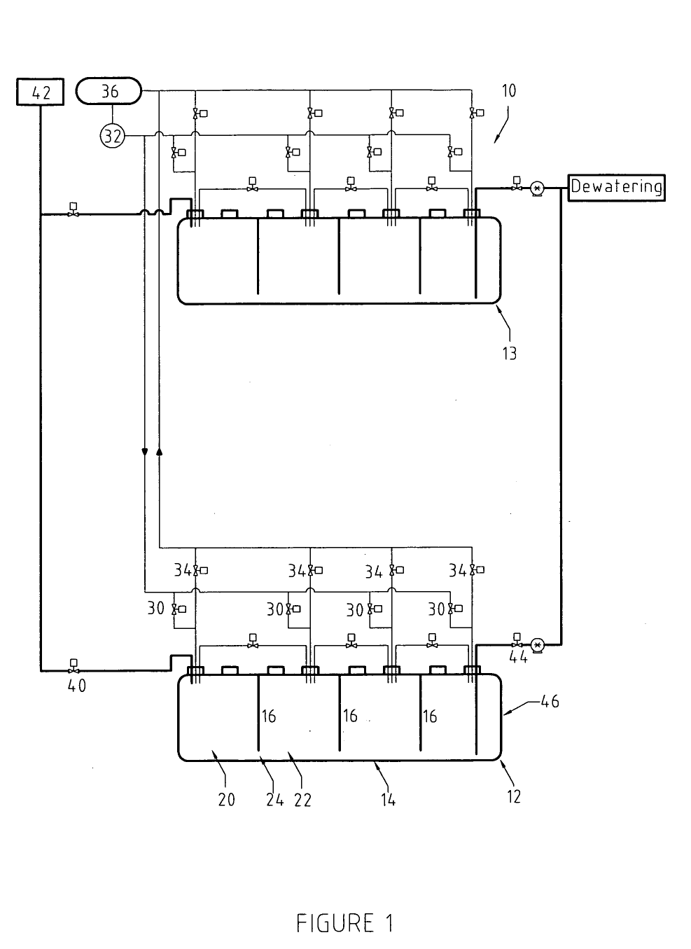

FIG. 1 shows apparatus 10 embodying the present invention, and comprising a plurality of reaction chambers 12, 13 working in parallel. The reaction chambers 12, 13 are identical and any number may be used in practice; however, for the sake of simplicity, only reaction chamber 12 will be described below. Reaction chamber 12 comprises a pressure vessel 14 with internal partitions 16 dividing its volume lengthwise into a number of cells connected in series, including a first chamber 20 and a second chamber 22. A total of four cells are shown in the reaction chamber 12, but this is a non-limiting example and just two cells will suffice. The first and second chambers 20, 22 are connected by a passageway 24 extending through the partition wall 16 therebetween. Each cell 20, 22 has a valve-controlled gas inlet duct 30 for receiving compressed gas from compressor 32, and a valve-controlled gas outlet duct 34 for removal of gas to gas store 36. The first cell also has a valve-controlled slurry inlet duct 40 for receiving organic waste slurry(s) from storage tank 42. A valve-controlled slurry outlet duct 44 is also provided for removing processed slurry at the downstream end 46 of the reaction chamber 12.

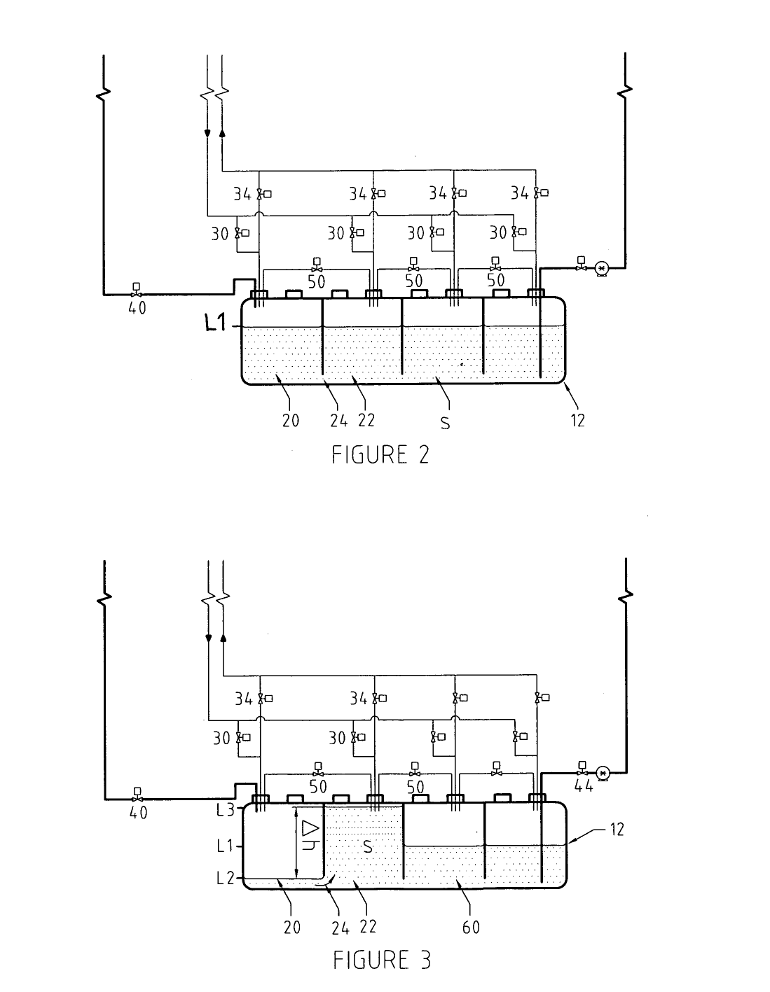

FIGS. 2 and 3 illustrate key stages in the anaerobic digestion of organic waste. At the start, organic waste slurry(s) is introduced in the reaction chamber 12 through valve-controlled slurry inlet duct 40. During such charging, valve-controlled gas outlet ducts 34 are open, so that the slurry(s) finds a common level (L₁) in each of the cells 20, 22. Valve-controlled links 50 ensure pressure equalisation between cells. Next, the valve-controlled outlet duct 34 extending from first cell 20 is closed, as are links 50, and the valve controlled inlet duct 30 to the first cell 20 is opened allowing gas from compressor 32 to be forced into the first cell 20. The incoming pressurized gas displaces slurry(s) from the first cell 20, through the passageway 24, building a head (Δh) of slurry in the second cell 22. The head of liquid is confined to the second cell by controlling pressures in cells downstream of the first and second cells. Once the head Ah of slurry(s) in the second cell 22 reaches a desired level (L₃), which may coincide with when the new level (L₂) of slurry(s) in the first cell has fallen to passageway 24, the first cell 20 is rapidly depressurized. Opening the valve-controlled link 50 between the first and second cells 20, 22 helps restore pressure equalisation between the first and second cells 20, 22. In this way, at least part of the head Δh of slurry(s) in the second cell 22 is rapidly discharged back to the first cell 20. Such a rapid discharge back-flushes the passageway 24 and agitates the slurry(s) to avoid phase separation.

The cycle of building a head of slurry in the second cell 22, and subsequently discharging it back to the first cell 20, may be repeated on a regular basis. However, at some point, it may be advantageous to use the slurry in the second cell 22 to build a new head of slurry in the next cell 60 in a downstream direction between inlet duct 40 and outlet duct 44, and subsequently discharge the new head back to the second cell 22. In this way, and by repeating this process to each pair of adjacent cells, a net gradual downstream movement of slurry may be achieved.

1. A method of anaerobically digesting organic material, comprising: providing a reaction chamber comprising first and second cells linked by a passageway for flow of organic waste slurry from a bottom region of one cell to a bottom region of another cell; placing an organic waste slurry in the reaction chamber to fill at least the bottom region of each cell; displacing organic waste slurry through the passageway from the first cell to the second cell to build a head of organic waste slurry in the second cell; and discharging the head of organic waste slurry from the second cell to agitate organic waste slurry in the reaction chamber.

2. A method according to claim 1, in which organic waste slurry is actively displaced by pressurizing the first cell relative to the second cell.

3. A method according to claim 2, in which the first cell is pressurized relative to the second cell by pumping gas into the first cell.

4. A method according to claim 3, in which the gas comprises at least a component of biogas.

5. A method according to claim 2, in which the head of organic waste slurry is discharged by rapidly depressurizing the first cell.

6. A method according to claim 1, in which at least some of the head of organic waste is discharged back into the first cell.

7. A method according to claim 1, in which the displacing and discharging steps are part of a cycle that is repeated during anaerobic digestion of organic material.

8. A method according to claim 7, in which the cycle is repeated continuously, at least during initial processing of organic waste.

9. Apparatus for anaerobic digestion of organic waste, comprising: a reaction chamber for receiving an organic waste slurry, the reaction chamber comprising first and second cells linked by a passageway for flow of organic waste slurry from a bottom region of one cell to a bottom region of another cell; means for displacing organic waste slurry through the passageway from the first cell to build a head of organic waste slurry in the second cell; and means for discharging the head of organic waste slurry from the second cell to agitate organic waste slurry in the reaction chamber.

10. Apparatus according to claim 9, in which the first cell is a pressure vessel, and the displacing means comprises a pump for pumping gas under pressure into the first cell.

11. Apparatus according to claim 10, in which the second cell comprises a vent for allowing the head of organic waste to build as gas is pumped under pressure into the first cell.

12. Apparatus according to claim 10, in which the discharging means comprises a valve for releasing pressurized gas from the first cell when activated.

13. Apparatus according to claim 12, in which the valve is configured to control flow of pressurized gas from the first cell to the second cell.
